(19) United States
(12) Patent Application Publication
(10) Pub. No.: US 2012/0174020 A1
(43) Pub. Date: Jul. 5, 2012

(54) INDICATION OF ACTIVE WINDOW WHEN SWITCHING TASKS IN A MULTI-MONITOR ENVIRONMENT

(75) Inventors: Denise A. Bell, Austin, TX (US); Fabio Carvalho, Austin, TX (US); John A. Christena, Austin, TX (US); Travis M. Grigsby, Austin, TX (US); Trevor Livingston, Austin, TX (US)

(73) Assignee: International Business Machines Corporation, Armonk, NY (US)

(21) Appl. No.: 12/983,142

(22) Filed: Dec. 31, 2010

(51) Int. Cl. G06F 3/048

(52) U.S. Cl. 715/779

(57) ABSTRACT

Exemplary embodiments disclose methods and systems for indicating a location of an active window when switching tasks performed by an application executing on a computer that is coupled to multiple monitors, including a primary monitor and at least one secondary monitor, wherein the primary monitor displays a task switching application showing running tasks. Aspects of the exemplary embodiments include: querying an operating system of the computer for monitor configuration, including a physical arrangement of the multiple monitors; in response to a user bringing to focus a task displayed in the task switching application, determining on which one of the one or more secondary monitors the task is running; and displaying a direction indicator indicating a direction of the one or more secondary monitors on which the in focus task is currently running with respect to the primary monitor.

### BACKGROUND

Today's widely-used operating systems support multitasking, which allows multiple tasks to run concurrently. The operating systems also include a graphical user interface in which open tasks are typically displayed on a monitor in respective overlapping windows. In the Windows Operating System (OS), for example, program icons and a taskbar are displayed on an interface known as the desktop and overlapping windows of open tasks are displayed over the desktop.

In Windows, the taskbar is displayed as a long horizontal bar at the bottom of the screen. Unlike the desktop, which can get obscured by open windows, the taskbar is almost always visible. The taskbar has three main sections: 1) a Start button, which opens the Start menu; 2) a middle section, which shows which programs and files are open and allows the user to quickly switch between them; and 3) a notification area, which includes a clock and icons that communicate the status of certain programs and computer settings.

Whenever a program, folder, or file is opened, Windows creates a corresponding taskbar button in the middle section on the taskbar that shows an icon representing the open program. The taskbar button corresponding to the active window is highlighted to indicate that the active window is in front of all other open windows and is ready for the user to interact with.

A user can switch from one active window to another via a variety of mechanisms. For example, to switch to another window, the user may click the window's corresponding taskbar button, bringing that window to the front of the desktop. Another way to change which open window is to press Alt+Tab. When the user presses Alt+Tab, a dialog box opens displaying the taskbar buttons of all open windows. To select a file, the user scrolls through the taskbar buttons and selects a desired button to make the corresponding window active (e.g., press and hold Alt and continues to press Tab until the desired window is highlighted and then release the keys).

The Mac OS is similar in that a user may open an application switcher by pressing Command+Tab to display a translucent window in the middle of the screen that shows icons of the running tasks. The icon of the last application used is highlighted and has a white box around it. The icon of the application currently being used may appear first, the next icon will be of the application used just before that, and so on. There are several ways to move through the applications. One option is for the user to continue pressing the tab key while holding down the Command key and the highlight will move to the right and then wrap around back to the beginning. Letting go of the tab key while the desired application is highlighted will bring that application to the front.

Most modern operating systems also provide support for running in a multi-monitor environment in which the computer is connected to two or more monitors. The desktop of the OS is extended to the multiple monitors. Typically, applications windows can be moved by the user to run/appear in the desired monitor. In Windows, the multi-monitor support displays the taskbar only in the primary monitor and the taskbar displays the applications from all of the monitors. The extended monitors are typically plain without any taskbar.

Often, while switching from one task to the next, particularly in a multi-monitor scenario, it is not clear where the switched-to application is going to appear. This forces the user to either scan the entire workspace until he finds the active application every time he switches tasks, or remember which task is displayed in each monitor.

In Windows 7, for example, when several application windows are open and the user selects an application from the taskbar by mouseovering one of the application preview windows, the OS makes all the other applications windows display only as an outline except the intended application, thus providing a preview of where the application window will appear on the monitor. The issue here is that the user has to scan the entire workspace, which may consist of several monitors to determine on which monitor the application is running.

Solutions exist for extending the Windows taskbar to multiple monitors. For example, Media Chance's MultiMonitor Taskbar™ creates secondary taskbars that are displayed on each extra monitor in a multi-monitor environment. Each taskbar, however, only displays task running on the corresponding monitor. The multi-monitor taskbar supports resizing windows and moving windows from move-to-monitor, as well as extending windows across multiple monitors. The multi-monitor taskbar, however, fails to address user confusion about where windows will be displayed in a large multi-monitor workspace.

RealTimeSoft's UltraMon™ adds an additional taskbar for each secondary monitor as well, and each taskbar only shows tasks from the monitor it is on. A side effect of displaying a taskbar on each monitor may be that the user can determine on which monitor a window will appear. But even with a taskbar per monitor, this still leaves a problem when using Alt+Tab to switch tasks because the Alt+Tab menu is displayed in all monitors, causing the user to have to know which task is on which monitor, or scan all the monitors or task bars when they wish to switch applications.

Accordingly, it would be desirable to provide a method and system for indicating a location of an active window when switching tasks.

### BRIEF SUMMARY

Exemplary embodiments disclose methods and systems for indicating a location of an active window when switching tasks performed by an application executing on a computer that is coupled to multiple monitors, including a primary monitor and at least one secondary monitor, wherein the primary monitor displays a task switching application showing running tasks. Aspects of the exemplary embodiments include: querying an operating system of the computer for monitor configuration, including a physical arrangement of the multiple monitors; in response to a user bringing to focus a task displayed in the task switching application, determining on which one of the one or more secondary monitors the task is running; and displaying a direction indicator indicating a direction of the one or more secondary monitors on which the in focus task is currently running with respect to the primary monitor.

### BRIEF DESCRIPTION OF SEVERAL VIEWS OF THE DRAWINGS

FIG. 1 is a diagram illustrating one embodiment of a system for indicating a location of an active window when switching tasks.

FIG. 2 is a flow diagram illustrating one embodiment of a process for indicating a location of an active window when switching tasks.

FIGS. 3A and 3B are block diagrams illustrating exemplary embodiments of displaying a direction indicator.

### DETAILED DESCRIPTION

The exemplary embodiment relates to a method and system for indicating a location of an active window when switching tasks. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

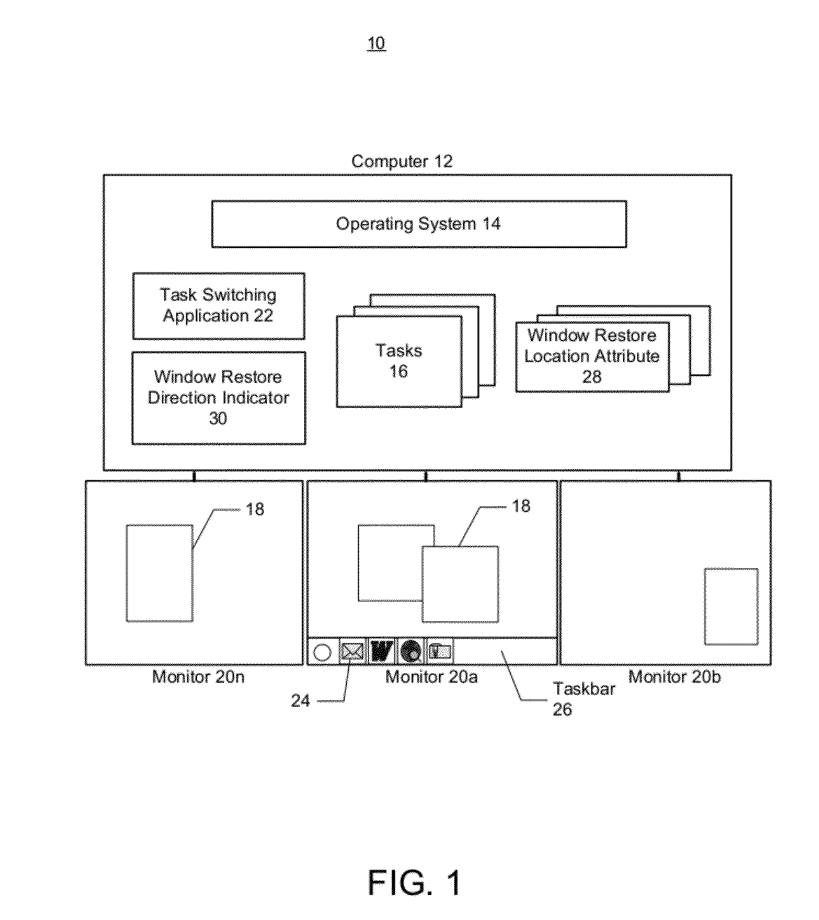

FIG. 1 is a diagram illustrating one embodiment of a system for indicating a location of an active window when switching tasks. The system 10 may include a computer 12 having an operating system 14 capable of executing various tasks 16, such as software applications, utility programs, and folders. As defined herein, a task 16 is a basic unit of programming that the operating system 14 controls. Depending on the operating system 14, a task 16 may be an entire program or each invocation of a program. Since one program may make requests of other utility programs, the utility programs may also be considered tasks (or subtasks). All of today's widely-used operating systems support multitasking, which allows multiple tasks to run concurrently.

In one embodiment, the operating system 14 also includes a graphical user interface in which open or running tasks 16 are typically displayed in respective overlapping windows 18 on one or more monitors 20a, 20b, 20n (collectively, monitors 20). Primary examples of modern operating systems include the Windows Operating System (OS), the Linux OS, and the Mac OS. The operating system 14 further includes some type of a task switching application 22 that is a space displayed on the monitor 20a showing tasks icons 24. The user can use the task switching application 22 to switch between tasks 16 by selecting one of the tasks icons 24.

Both the GUI of the operating system 14, including the task switching application 22, and the windows 18 of running tasks 16 may be controlled by user computer input devices (not shown), such as a keyboard and/or a pointing device, such as a mouse or stylus. In some embodiments, one or more of the monitors 20 may be touch screen enabled, which enables the applications 18 be used with a variety of pointing devices, including the user's finger and various types of styluses.

Using the input devices, the user may select one of the task icons 24 shown by the task switching application 22, which makes the window 18 of the corresponding task 16 the currently active window that is displayed on top of all other windows 18. Some examples of task switching applications 22 include a taskbar 26 as in Windows and Linux, or an application bar in the Mac OS. Another example in both Windows and Mac is an applications switcher that is accessed by pressing Alt-Tab keys in Windows, and on a Mac, is accessed by holding down a Command key and then tapping the Tab key. The operating system 14 may maintain the size and location of each of the windows 18 by a window restore location attribute 28 that is associated with each of the tasks 16 and their corresponding windows 18.

The system 10 is shown operating in a multi-monitor environment in which the computer is connected to a primary monitor 20a and secondary monitors 20b and 20n (collectively, monitors 20). In the multi-monitor environment, the GUI of the operating system 14, such as the Windows desktop, is extended to the multiple monitors. The user can move the windows such that the tasks 16 are displayed and appear to run in the desired monitor 20. In most operating systems, the multi-monitor support displays the taskbar 26 only in a primary monitor (e.g., monitor 20a) and the taskbar 26 displays the task from all of the monitors 20. When switching from one application to the next, it is not clear to the user in which of the monitors 20 the switched-to application will be displayed. This forces the user to either scan the entire workspace until he finds the active application every time he switches tasks 16, or remember which task is displayed in each monitor 20.

According to the exemplary embodiment, the computer 12 is provided with a window restore direction indicator 30. The window restore direction indicator 30 monitors the physical layout of the monitors 20 and the window restore location attributes 28 of the running tasks 16. In response to a user bringing a task icon 24 into focus in the task switcher application 22 (e.g., by mousing over the task icon 24), the window restore direction indicator 30 displays an indication of the location of the window corresponding to the selected icon, as described further below.

In one embodiment, the window restore direction indicator 30 may be an application separate from the operating system 14. In another embodiment, the window restore direction indicator 30 may be part of the operating system 14. In yet another embodiment, the window restore direction indicator 30 may be made part of the code comprising the task switching application 22.

The computer 12 may exist in various forms, including a personal computer (PC), (e.g., desktop, laptop, or notebook), a smart phone, a personal digital assistant (PDA), a set-top box, a game system, and the like. The computer 12 may include hardware components of typical computing devices (not shown), including a data processing system, input devices (e.g., keyboard, pointing device, microphone for voice commands, buttons, touch screen, etc.), and output devices (e.g., a display device, speakers, and the like). The computer 12 may include computer-readable media, e.g., memory and storage devices (e.g., flash memory, hard drive, optical disk drive, magnetic disk drive, and the like) containing computer instructions that implement the functionality disclosed when executed by the processor. The computer 12 may further include wired or wireless network communication interfaces for communication.

The data processing system that stores and/or executes program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

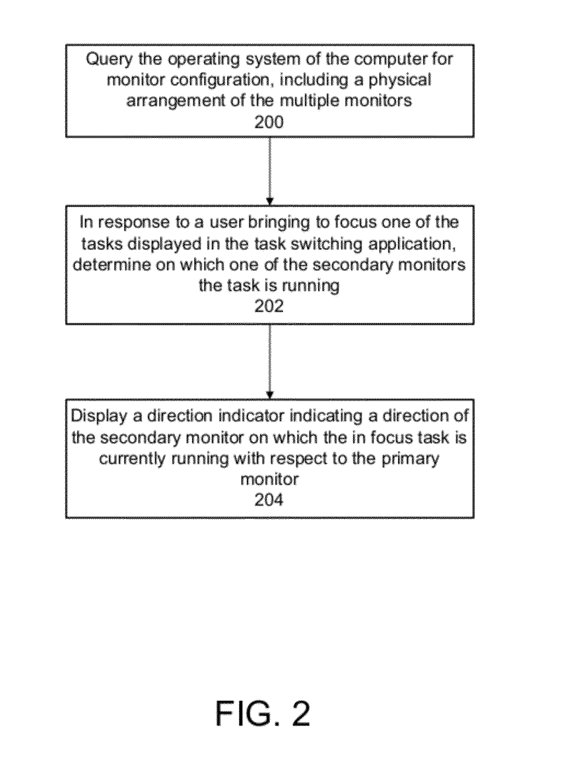

FIG. 2 is a flow diagram illustrating one embodiment of a process for indicating a location of an active window when switching tasks. The process may include the window restore direction indicator 30 querying the operating system of the computer for monitor configuration, including a physical arrangement of the multiple monitors (step 200). In one embodiment, the window restore direction indicator 30 may store the monitor configuration and may query the operating system 14 periodically to refresh the stored monitor configuration. The monitor configuration information may include the number of monitors, which monitor is designated as a primary monitor, and the physical arrangement of the monitors, e.g., secondary monitor number two is located to the left of primary monitor, or the top of monitor number two is at a center axis of monitor number one. The monitor configuration information may also include an identification of the monitor 20 or workspace that contains the current mouse pointer, and the monitor 20 or workspace that contains the task switching application 22 if it is limited to one of the monitors 20.

In one embodiment, in addition to multiple monitors, the operating system 14 may support virtual workspaces, as in the Linux operating system. In this embodiment, the window restore direction indicator 30 may also query the operating system 14 for workspace configuration as well. As defined herein, the term monitor configuration is intended to also include any workspace configuration.

In response to a user bringing to focus one of the tasks displayed in the task switching application, the window restore direction indicator 30 determines on which one of the secondary monitors the task is running (step 202). In one embodiment, the user may bring a task 16 to focus by causing the icon 24 of the task to be highlighted in the task switching application 22. For example, if the task switching application 22 is a taskbar 26, then the user can bring a task displayed in the taskbar 26 to focus by placing the mouse pointer over the icon for the task and sliding the cursor upwards causing the icon to be highlighted and a preview window for the task to be displayed. As another example, if the task switching application 22 is a switching application, such as the Alt+Tab switching window, then the user can bring each displayed task to focus by scrolling through the task icons with the arrow keys or the mouse pointer.

In response to a task being bought into focus in the task switching application 22, the window restore direction indicator 30 accesses the window restore location attribute 28 of the task to determine which monitor the task is running or displayed on. To access the window restore location attribute 28, the window restore direction indicator 30 may query a component that maintains the window restore location attribute 28, which may include the task window, a parent process (e.g. explorer.exe), the operating system, or the application metadata registry.

In response to determining the task is running on a secondary monitor, the window restore direction indicator 30 displays a direction indicator indicating a direction of the secondary monitor on which the in focus task is currently running with respect to the primary monitor (step 204).

Based on the monitor configuration information and the knowledge of the which secondary monitor the task is running on, the window restore direction indicator 30 can determine the location or position of the secondary monitor relative to the primary monitor, e.g., left, right, up, or down, and then display an indication corresponding to of one of those directions. It should be understood that in embodiments where the task switching application is extended to multiple monitors 20, the monitor in which the test switching application displays the in focus task icon may be considered the primary monitor 20a, such that the direction indicator indicates a direction relative to that monitor 20a. As used herein, the term direction indicator may include configurations where the direction indicator is configured to indicate a location of the monitor running the task with respect to other monitors and/or a location of the task window within that monitor.

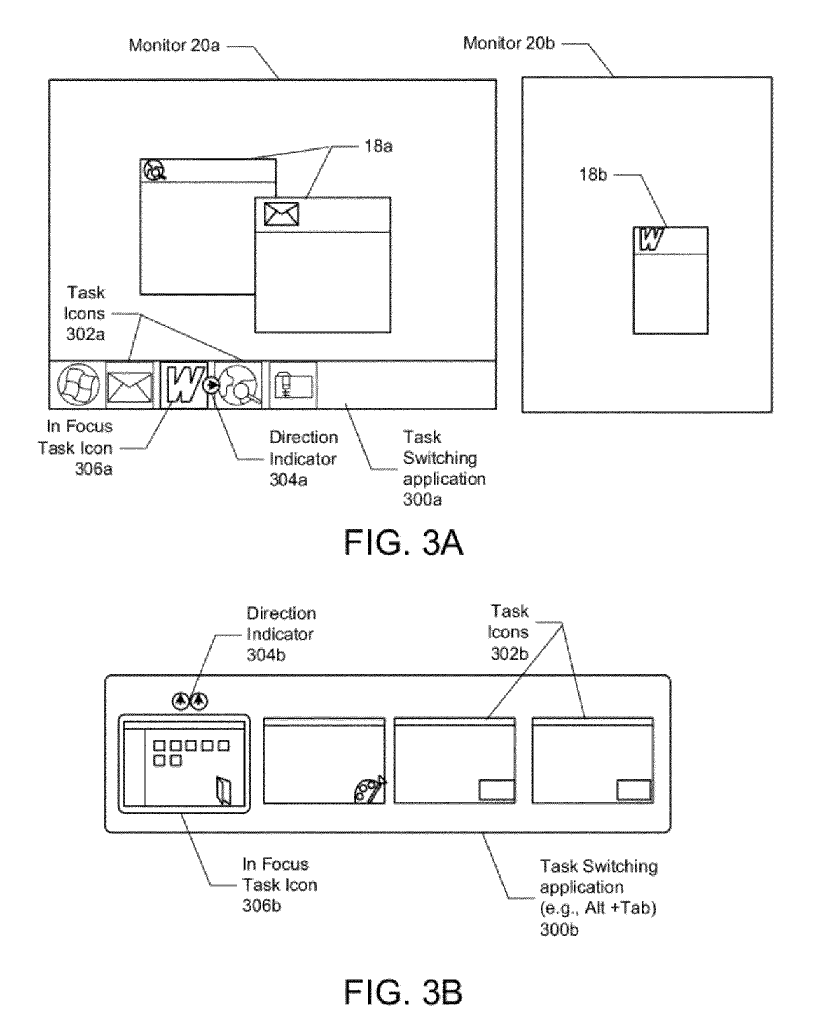

FIGS. 3A and 3B are block diagrams illustrating exemplary embodiments of displaying a direction indicator. FIG. 3A shows an embodiment where the task switching application 300 is a taskbar that is displayed in a primary monitor 20a. The task switching application 300 displays task icons 302a corresponding to task windows 18a and 18b that are displayed in both the primary monitor 20a and the secondary monitor 20b.

In accordance with the exemplary embodiment, when the user brings to focus one of the task icons 302a in the task switching application 300a, i.e., the in focus task icon 306a, the window restore direction indicator 30 displays a direction indicator 304a that indicates to the user the direction of the monitor on which the active window corresponding task will appear. In this example, the direction indication 304a is a right arrow, which points towards the position of secondary monitor 20b with respect to the primary monitor 20a.

The direction indicator 304a may be provided in any form, such as an icon, picture, graphic or text that indicates a direction in relation to the current monitor/workspace of where a user should look in order to find the open task. Examples of suitable direction indicators 304a include an arrow, a finger, a compass, and the like. The direction indicator 304a may optionally indicate a distance for multiple monitor distances. For example a single arrow > may indicate a monitor immediately adjacent to the current monitor, whereas a double right arrow >> might indicate a location multiple monitors to the right of the current monitor.

In another embodiment, the direction indicator 304a may be optionally displayed with relative sizes or colors to provide more fine-grained location information, e.g., a longer arrow represents a longer distance. For example, the direction indicator 304a may be an arrow that points higher for a task that resides on a monitor located high in a stack from the current monitor, and may be a shorter arrow for one that resides on a monitor located lower in the stack.

In a further embodiment, the direction indicator may be configured to include an indication that the in focus task is running on the primary monitor. For example, if the task in focus is on the current or primary monitor 20a, then the direction indicator 304a may be configured to indicate the task is running on the current or primary monitor 20a. For example, the direction indicator 304a may be displayed as a dot or as a star, for instance. Alternatively, the direction indicator 304a need not be displayed when the in focus task is running on the primary monitor.

FIG. 3B shows another example in which the task which application corresponds to the Alt+Tab dialog box in Windows. The task switching application 300b displays task icons 302b of all open tasks. The currently in focus task icon 306b is shown highlighted. In accordance with the exemplary embodiment, a direction indicator 304b is shown above the in focus task icon 306b. In this example, the direction indicator 304b is a double up arrow, which may indicate that the monitor on which the open task is running is positioned two monitors up from the current monitor.

In a further embodiment, the direction indicator 304a and 304b (collectively, direction indicator 304) may comprise a monitor/workspace preview window that displays all monitors/workspaces, where a type of highlight indicates a location of the in focus task icon 306a or 306b (collectively, in focus task icon 306). In one embodiment, the preview may show a relative location of the in focus task icon 306 within a particular monitor 20 or workspace. Monitors for workspaces that do not currently display a running task may be omitted from the monitor/workspace preview.

In one embodiment, the direction indicator 304 may be displayed in proximity to the user's focal point, where the focal point of the user is the task switching application 300. More specifically, the focal point of the user may comprise the in focus task icon 306. In other words, the direction indicator 304 may be displayed within or adjacent to the task switching application 300. In another embodiment, the direction indicator 304 may be displayed overlaid on or next to the in focus task icon 306 in the task switching application 300a and 300b. In yet another embodiment, the direction indicator 304 may be displayed overlaid on or next to the monitor/workspace preview window.

In a further embodiment, multiple arrows or other indicators to be used for a stack of tasks, such as multiple Firefox windows, or for a type of task that when switched to, will result in multiple windows coming to a top of a Z-order.

A methods and systems for indicating a location of an active window when switching tasks has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for indicating a location of an active window when switching tasks performed by an application executing on a computer that is coupled to multiple monitors, including a primary monitor and at least one secondary monitor, wherein the primary monitor displays a task switching application showing running tasks, the method comprising:
querying an operating system of the computer for monitor configuration, including a physical arrangement of the multiple monitors;
in response to a user bringing to focus a task displayed in the task switching application, determining on which one of the one or more secondary monitors the task is running; and
displaying a direction indicator indicating a direction of the one or more secondary monitors on which the in focus task is currently running with respect to the primary monitor.

2. The method of claim 1 further comprising determining a position of the one secondary monitor relative to the primary monitor based on the monitor configuration information and knowledge of the which one of the one or more secondary monitors on which the task is running, and then displaying the indication corresponding to of one of those directions.

3. The method of claim 1 further comprising displaying the direction indicator as at least one of an icon, a picture, a graphic, and text that indicates the direction relative to the primary monitor.

4. The method of claim 3 further comprising displaying the direction indicator such that a distance is indicated for multiple monitor distances.

5. The method of claim 1 further comprising displaying the direction indicator with at least one of relative sizes and colors to provide fine-grained location information.

6. The method of claim 1 further comprising displaying the direction indicator with multiple indicators to be used for at least one of a stack of tasks and a type of task that when switched to, will result in multiple windows coming to a top of a Z-order.

7. The method of claim 1 further comprising displaying the direction indicator as a preview window that displays of at least one of the multiple monitors and multiple workspaces, where a type of highlight indicates a location of the in focus task.

8. The method of claim 1 wherein a focal point of the user is the task switching application, the displaying step further including displaying the direction indicator in proximity to the user focal point.

9. The method of claim 8 wherein the displaying step further includes displaying the indicator in proximity to the task switching application.

10. The method of claim 8 wherein the displaying step further includes displaying the indicator in proximity to an icon representing the task in the task switching application.

11. The method of claim 1 further comprising configuring the direction indicator to indicate a direction of one or more workspaces on which the in focus task is currently running.

12. The method of claim 1 further comprising configuring the direction indicator to include an indication that the in focus task is running on the primary monitor.

13. An executable software product stored on a computer-readable medium containing program instructions for indicating a location of an active window when switching tasks performed by an application executing on a computer that is coupled to multiple monitors, including a primary monitor and at least one secondary monitor, wherein the primary monitor displays a task switching application showing running tasks, the program instructions for:
querying an operating system of the computer for monitor configuration, including a physical arrangement of the multiple monitors;
in response to a user bringing to focus a task displayed in the task switching application, determining on which one of the one or more secondary monitors the task is running; and
displaying a direction indicator indicating a direction of the one or more secondary monitors on which the in focus task is currently running with respect to the primary monitor.

14. The executable software product of claim 13 further comprising program instructions for determining a position of the one secondary monitor relative to the primary monitor based on the monitor configuration information and knowledge of the which one of the one or more secondary monitors on which the task is running, and then displaying the indication corresponding to of one of those directions.

15. The executable software product of claim 13 further comprising program instructions for displaying the direction indicator as at least one of an icon, a picture, a graphic, and text that indicates the direction relative to the primary monitor.

16. The executable software product of claim 15 further comprising program instructions for displaying the direction indicator such that a distance is indicated for multiple monitor distances.

17. The executable software product of claim 13 further comprising program instructions for displaying the direction indicator with at least one of relative sizes and colors to provide fine-grained location information.

18. The executable software product of claim 13 further comprising program instructions for displaying the direction indicator with multiple indicators to be used for at least one of a stack of tasks and a type of task that when switched to, will result in multiple windows coming to a top of a Z-order.

19. The executable software product of claim 13 further comprising program instructions for displaying the direction indicator as a preview window that displays of at least one of the multiple monitors and multiple workspaces, where a type of highlight indicates a location of the in focus task.

20. The executable software product of claim 13 wherein a focal point of the user is the task switching application, the displaying step further including program instructions for displaying the direction indicator in proximity to the user focal point.

21. The executable software product of claim 20 wherein the displaying step further includes program instructions for displaying the indicator in proximity to the task switching application.

22. The executable software product of claim 20 wherein the displaying step further includes program instructions for displaying the indicator in proximity to an icon representing the task in the task switching application.

23. The executable software product of claim 13 further comprising program instructions for configuring the direction indicator to indicate a direction of one or more workspaces on which the in focus task is currently running.

24. The executable software product of claim 13 further comprising program instructions for configuring the direction indicator to include an indication that the in focus task is running on the primary monitor.

25. A system comprising:
a primary monitor and at least one secondary monitor;
a computer coupled to the primary monitor and the at least one secondary monitor, the computer comprising a memory and a processor, wherein the processor executes multiple tasks and displays on the primary monitor displays a task switching application showing running tasks;
a window restore direction indicator component executing on the computer, the window restore direction indicator component configured to:
query an operating system of the computer for monitor configuration, including a physical arrangement of the multiple monitors;
in response to a user bringing to focus a task displayed in the task switching application, determine on which one of the one or more secondary monitors the task is running; and
display a direction indicator indicating a direction of the one or more secondary monitors on which the in focus task is currently running with respect to the primary monitor.
